(19) United States
(12) Patent Application Publication
(10) Pub. No.: US 2016/0112708 A1
(43) Pub. Date: Apr. 21, 2016

(54) SYSTEM AND METHOD FOR OPTIMIZING INTENSITY LEVELS FOR VIDEO ENCODING

(71) Applicant: Trusight, Inc., Cupertino, CA (US)

(72) Inventor: Kevin P. Grundy, Fremont, CA (US)

(21) Appl. No.: 14/918,106

(22) Filed: Oct. 20, 2015

Related U.S. Application Data
(60) Provisional application No. 62/066,197, filed on Oct. 20, 2014.

(51) Int. Cl. H04N 19/136

(52) U.S. Cl. CPC H04N 19/136

(57) ABSTRACT

A system for adjusting the compression of one or more digital images comprising an image luminance compressor with video encoder control outputs and a video encoder with control inputs coupled to the image luminance compressor control outputs.

### RELATED APPLICATIONS

This application claims priority from U.S. provisional application No. 62/066,197 filed on Oct. 20, 2014 which is all incorporated by reference herein in its entirety.

### FIELD OF THE INVENTION

The present invention relates to the field of image processing.

### BACKGROUND

The increase in the consumption of digital video has correspondingly accelerated development efforts to make video compression more efficient while maintaining image quality. Many proposed improvements for increasing efficiency are based upon algorithmic changes not associated with the type and makeup of particular images. As an example, the H.264 video encoding algorithm generally uses an 8×8 pixel block size for its basic computational unit. The 8×8 computational unit used for H.264 was set over twenty-five years ago when CPU processing was several orders of magnitude lower than what it is today. More recent standards such as H.265 standard makes use of a 64×64 pixel block size thereby increasing efficiency regardless of the type of images fed into the video encoder.

There are additional video encoding optimizing techniques which take advantage of the type of material being encoded. Many discrete cosine transformation (DCT) based encoders evaluate the amount of motion between frames and correspondingly adjust their quantizer in an effort to obtain the best balance between pixel block fidelity and adequately displaying motion.

FIG. 1 illustrates an example of a video encoder in the relevant art wherein a coding control block orchestrates the generation of a compressed video stream from both DCT'd pixel blocks and motion estimation information generated from input images. The baseline operating characteristic of the video encoder is set from external encoding parameters. In general, these parameters are set once and remain unchanged as images are fed into the video encoder. As the video encoder converts images into a compressed video bit stream, the coding control block keeps track of the target bit stream and adjusts the operation of each of the encoder components ensuring that bit stream stays within the encoding parameters set forth. The coding control block also provides statistics which can be used to determine how well the video encoder is operating.

U.S. Pat. No. 6,901,164 “Method for Automated High Speed Improvement of Digital Color Images” that issued on May 31, 2005 to Moredechai Sheffer, which is incorporated herein by reference in its entirety, describes methods for optimizing an image making use of the simultaneous processing of light and dark compression using Weber curves. FIG. 2 illustrates enhancements to U.S. Pat. No. 6,901,164 described in U.S. pat. appl. Ser. No. 13/932,231 to Kevin P. Grundy, filed on Jul. 1, 2013 entitled “System and Method for Automatic Presets in Dynamic Range Compression Image Processing,” which is incorporated herein by reference herein in its entirety. Digital images are enhanced via light and dark compression based upon either user selected parameters or those generated from the image itself. Furthermore, Grundy teaches how additional input to the DRC processing provides for additional benefit through monitoring of the resulting image in the environment where it is used. In FIG. 2, one example is shown as a light sensor monitoring a display rendering the processed image.

FIG. 3 illustrates a typical system whereby images are processed with dynamic range compression and fed into a video encoder. Users of this type of system set both DRC parameters and video encoding parameters usually according to the type of images being processed. The processing takes place while the parameters remain fixed. While both the DRC processor and the video encoder each processes independently according to the image(s) being used, their independent processing does not necessarily fully optimize the generation of an encoded video bit stream.

A particularly vexing problem associated with video encoders is the processing of large areas of equal or near equal luminance within an image. Small changes in image luminance levels on defined boundaries are easily discerned by the human eye. If a group of pixels within an image is generally black but their levels vary slightly and randomly distributed throughout the group, the human eye will not necessarily see this as unnatural or offensive. However, if a small uniform change in black level occurs at a well-defined boundary, the human eye will readily discern the line and may cause the perception of lower quality. Unfortunately for many video encoders, the use of fixed blocks for pixel processing creates regular pixel boundaries within compressed video images.

As outlined in U.S. Pat. No. 6,901,164, pixel luminance levels may be adjusted to better match the perception of the human eye. FIG. 4 illustrates a Weber curve that adjusts an image towards overall lower luminance levels. The X axis represents an input pixel luminance value and the Y axis represents dynamic range compression adjustment through the Weber curve. The shape of the Weber curve in FIG. 4 lessens the difference of black levels between incoming pixels at the black end of the range (0 to ˜75) and enhances levels between incoming pixels at the light end of the range (˜200 to 255). For a video transcoder, this particular flattening of pixel black levels would be advantageous in lowering the difference between adjoining black encoding macro blocks and thereby improving the quality of the encoding. FIG. 5 illustrates a Weber curve that adjusts an image towards overall higher luminance levels. In this particular case, black levels differences are enhanced thereby exacerbating the video encoder's ability to create a video stream without black macro block artifacts.

Using preprocessing to enhance image intelligibility is beneficial for a variety of purposes. The DRC process described in U.S. Pat. No. 6,901,164 creates images which can be viewed on displays which require less energy. These images may also be capable of being compressed to a higher level and therefore can provide transport bandwidth savings. However, when using preprocessing with a video encoder, the preprocessor may adjust luminance levels which cause the video encoder to generate bit streams with enhanced visual artifacts due to the algorithm of the video encoder. Alternately, the use of a preprocessor may adjust luminance levels which cause the video encoder to increase bit output bit rates.

Various embodiments make use of techniques for signaling between a dynamic range compressor and a video encoder to achieve optimal visual quality and bit rates for encoded bit streams.

### SUMMARY

A system for adjusting the compression of one or more digital images comprising an image luminance compressor with video encoder control outputs and a video encoder with control inputs coupled to the image luminance compressor control outputs.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

Embodiments are illustrated by way of example, and not by way of limitation, in the figures of the accompanying drawings and in which like reference numerals refer to similar elements and in which:

FIG. 1 is a block diagram of a video encoder in the relevant art.

FIG. 2 is a block diagram of a DRC image processing system in the relevant art with dynamic range adjusting controls.

FIG. 3 is a block diagram of a DRC image processing system feeding into a video encoder in the relevant art.

FIG. 4 is a DRC Weber curve that flattens out black pixel levels in the relevant art.

FIG. 5 is a DRC Weber curve that enhances black pixel levels in the relevant art.

FIG. 6 is a block diagram of an embodiment of a DRC Setting Processor coupled to a video encoder with feedback and feedforward control paths in accordance with embodiments.

FIG. 7 is a representative block diagram of a Video Encoder with feedback and feedforward control paths in accordance with embodiments.

FIG. 8 is a representative block diagram of a dynamic range compressor with feedback and feedforward control paths in accordance with embodiments.

FIG. 9 is a flow diagram of dynamic range compressor passing feed forward data to a video encoder in accordance with embodiments.

FIG. 10 is a flow diagram of dynamic range compressor passing feed forward data to a video encoder and the video encoder passing feed back data to the dynamic range compressor in accordance with embodiments.

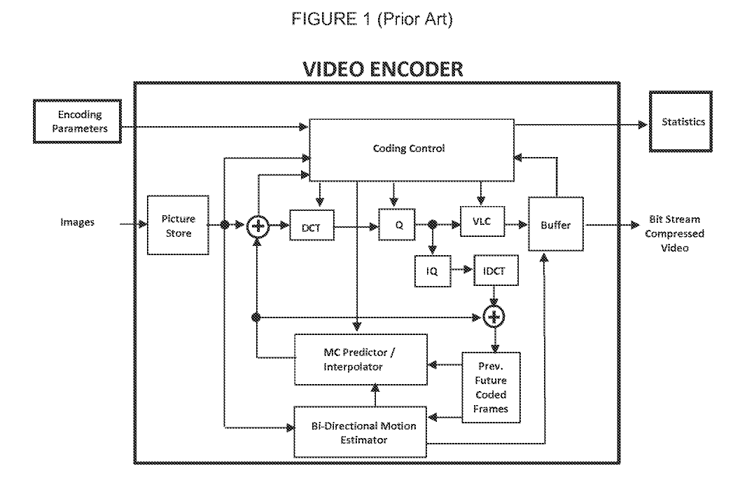

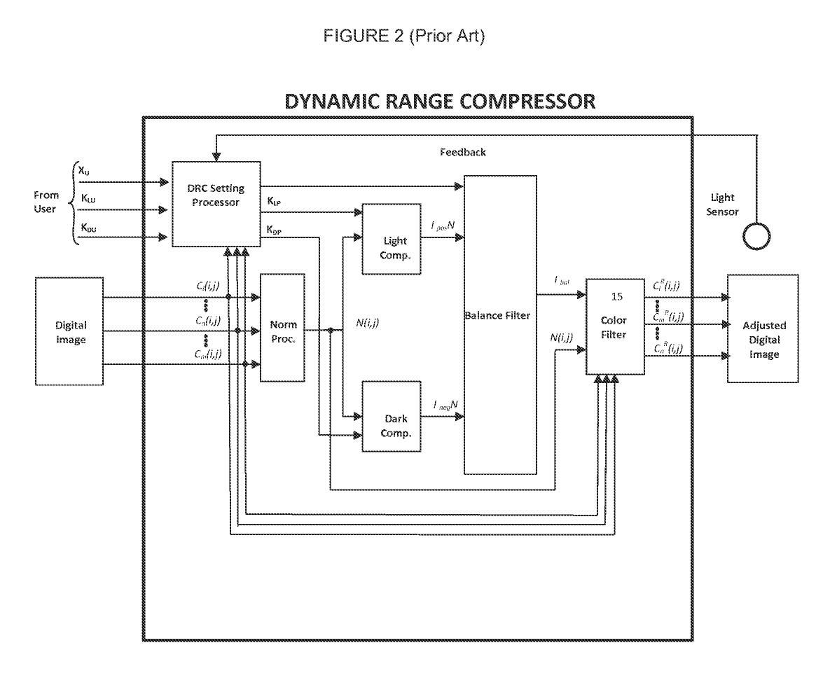

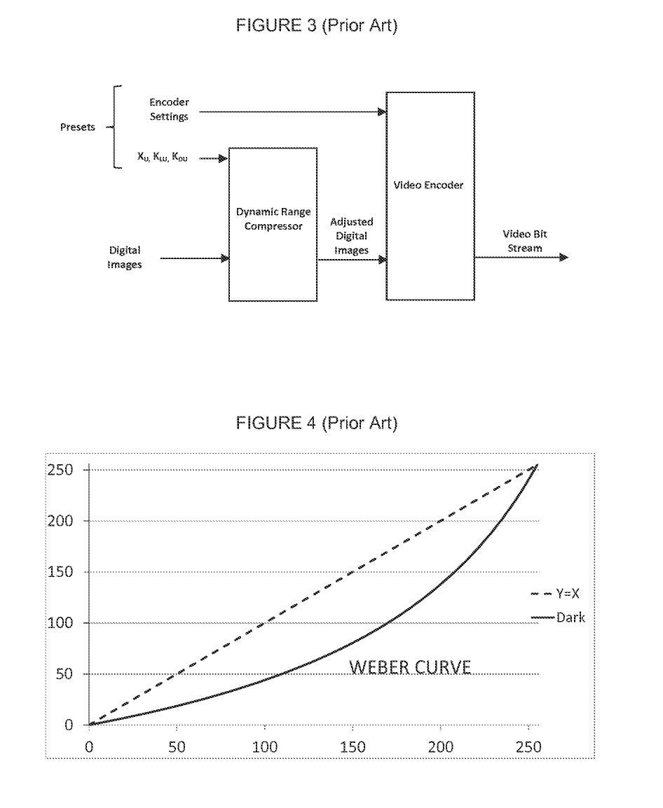

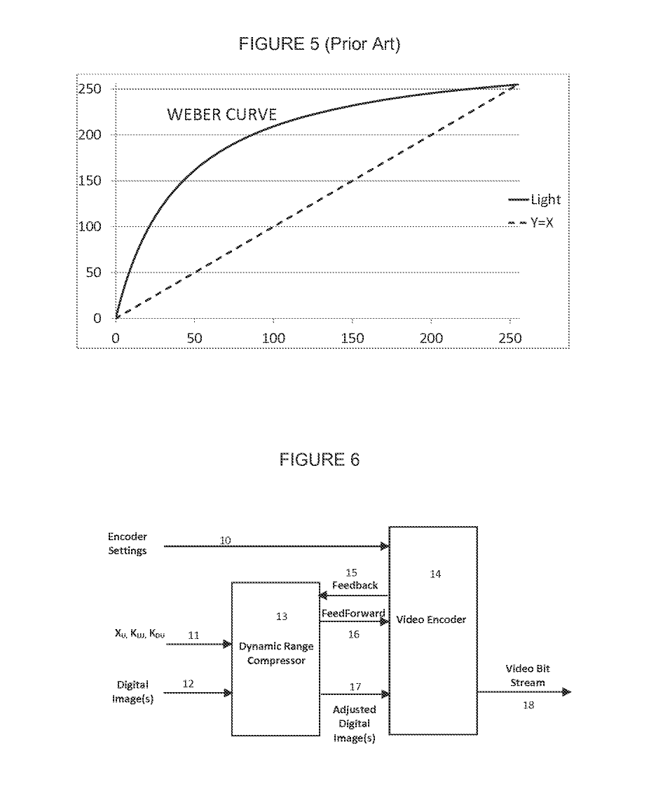

The figures depict various embodiments for purposes of illustration only. One skilled in the art will readily recognize from the following discussion that alternative embodiments of the structures and methods illustrated herein may be employed without departing from the principles of the embodiments described herein.

### DETAILED DESCRIPTION

Embodiments are now described with reference to the figures where like reference numbers indicate identical or functionally similar elements.

In the following description and in the accompanying drawings, specific terminology and drawing symbols are set forth to provide a thorough understanding of the embodiments. In some instances, the terminology and symbols may imply specific details that are not required to practice the embodiments. For example, a processing block may either be implemented in software or hardware. Digital representations of numerical quantities are not limited to specific number of bit accuracies. Computations required to implement the embodiments are not limited to fixed or floating point or any combination thereof. In the following description and block diagrams, reference is made to color components Cⱼ, Cₙ, Cₘ. Representations of color spaces are not limited to three components. Representations of color space using luma (luminance) and chroma are ubiquitous and are anticipated. One common representation of images utilizes separate luminance (Y) and chroma (U & V) while RGB is another. In the following description, references made to Digital Images include both still and moving. In the following descriptions, operator inputs such as X_{U}, K_{LU}, K_{DU} for the Dynamic Range Compressor are not limited to these and may include other controls.

FIG. 6 illustrates an embodiment wherein a Dynamic Range Compressor 13 is coupled to a Video Encoder 14. The Dynamic Range Compressor 13 is upstream of the Video Encoder 14 and receives Digital Images 12 from prerecorded or live image or video sources. The Dynamic Range Compressor 13, in this embodiment, has operator inputs X_{U}, K_{LU}, K_{DU} 11 which are set by an operator. The Dynamic Range Compressor 13 analyzes the incoming Digital Images 12 and processes it using a combination of the analyzed Digital Images 12 and operator inputs X_{U}, K_{LU}, K_{DU} 11. The output of the Dynamic Range Compressor 13 are the Adjusted Digital Images 17 which are fed into the Video Encoder 14. The Video Encoder 14 has its own operator input shown as Encoder Settings 10. The Video Encoder 14 processes the Adjusted Digital Images 17 according to the Encoder Settings 10 and produces a Video Bit Stream 18. The arrangement of the Dynamic Range Compressor 13 feeding the Video Encoder 14 with operator input via Encoder Settings 10 and operator inputs X_{U}, K_{LU}, K_{DU} 11 results in a Video Bit Stream 18. The Dynamic Range Compressor 13 and the Video Encoder 14 operating independently does not always provide for the optimum processing of Digital Images 12 into a Video Bit Stream 18. This is due to potential decisions being made within Video Encoder 14 according to the encoder algorithm which may generate enhanced visual artifacts. An example of this condition arises when a motion picture has elements of high motion and large areas of consistent luminance. A runner with reflective clothing illuminated while running at night with a dark background has both high motion and large areas of constant luminance. Furthermore, if the Encoder Settings 10 are set so that the Video Encoder 14 is to generate a very low bit rate Video Bit Stream 18, the conditions exist for the Dynamic Range Compressor 13 and the Video Encoder 14 to work against each other insofar as generating a quality bit stream. The operator inputs X_{U}, K_{LU}, K_{DU} 11 may be set to increase the dynamic range of the black levels of the Adjusted digital Images 17. However, owing to a low bit rate constraint set by the Encoder Settings 10, the Video Encoder would necessarily allocate more of its encode bits for motion vector generation taking away bits from the DCT representations of the macro blocks. Adjoining macro blocks would become very visible as their luminance values would be slightly different owing to the lack of resolution from the DCT. This condition would be exacerbated if the Dynamic Range Compressor 13 is set to increase the differences in dark areas. While this particular explanation is presented for large areas of common luminance level dark areas, it also applies to images with large common luminance level light areas. To improve the Dynamic Range Compressor 13 and Video Encoder 14 cascade for processing Digital Images 12, the addition of Feedback 15 and Feedforward 16 control paths are added. The addition of these two control links provides a necessary communication between the Dynamic Range Compressor 13 and the Video Encoder 14 to optimize the Video Bit Stream 18.

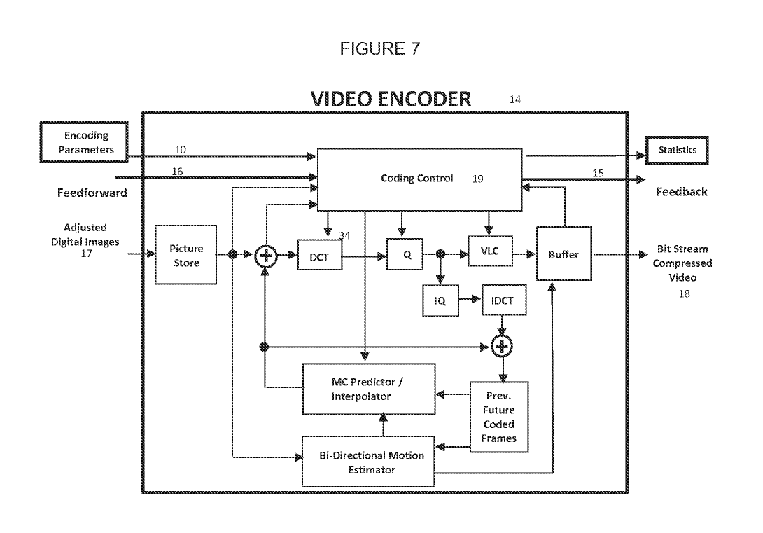

FIG. 7 illustrates an embodiment showing a Feedforward 16 path and a Feedback 15 path connected to a Video Encoder 14. The Feedforward 16 information is comprised of parameters from the Dynamic Range Compressor 13 (FIG. 6) which conveys to the Video Encoder 14 the nature of the dynamic range compression operation that was applied to the incoming Images 17. In one embodiment these parameters consist of the level of compression used for the Adjusted Digital Images 17. In other embodiments, these parameters are comprised of additional information such as the amount of spatial filtering used, specific pixel area locations where pixels were processed differently from other areas, gain levels or offsets. In one embodiment specific to the Video Encoder shown in FIG. 7, Feedforward 16 information drives the Coding Control 19 logic of the Video Encoder 14. The Feedforward 16 information supplied by the Dynamic Range Compressor (FIG. 6) is used by the Video Encoder in cooperation with its own computations to optimize the encoding process. In one example, the Feedforward 16 information provides to the Coding Control 19 that high levels of dynamic range have been applied to the incoming pixels in the low luminance range wherein the Coding Control 19 may allocate more bits for the DCT 34 to process low luminance pixels. In the opposite case, the Feedforward 16 information provides to the Coding Control 19 that low levels of dynamic range have been applied to the incoming pixels in the low luminance range wherein the Coding Control 19 may allocate less bits for the DCT 34 to process low luminance pixels thereby leaving more encode bits for motion vector. In other embodiments, the Feedforward 16 information drives other video encoder functional blocks. The Feedforward 16 information in one embodiment is individually associated with individual incoming Images 17 while in another embodiment the Feedforward 16 information is associated with a group or sequence of images. The Feedforward 16 information is comprised of but not limited to numerical representations of the amount of light compression, dark compression, the balance between light and dark compression used in the Dynamic Range Compressor 13.

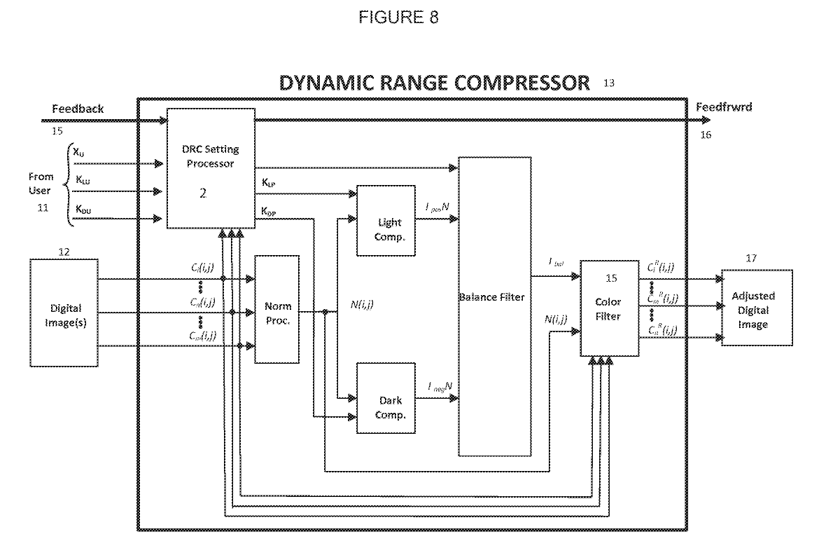

FIG. 8 illustrates an embodiment showing the Feedforward 16 path and the

Feedback 15 path within a Dynamic Range Compressor 13. The Feedback 15 information is comprised of parameters from the Video Encoder 14 which conveys to the Dynamic Range Compressor 13 the nature of the encoding process taking place within the Video Encoder. In one embodiment Feedback 15 information drives the DRC Setting Processor 20 logic of the Dynamic Range Compressor and is comprised of the amount of motion vectors needed by the Video Encoder 14 (FIG. 7). High numbers of motion vectors signals the DRC Setting Processor 2 that higher levels of dynamic range compression may be used and not affect overall image quality from the Video Encoder 14 (FIG. 7). Conversely, low numbers of motion vectors signals the DRC Setting Processor 2 that lower levels of dynamic range compression may be needed to not adversely affect overall image quality from the Video Encoder 14 (FIG. 7). In other embodiments, the Feedback 15 information drives other Dynamic Range Compressor 13 functional blocks. The Feedback 16 information in one embodiment is individually associated with individual incoming Images 17 while in another embodiment the Feedback 15 information is associated with a group or sequence of images. The Feedback 15 information is comprised of but not limited to numerical representations of the video encoder 14 internal algorithm quantities of quantization, bit rate and motion vector quantity.

The processing and exchange of feedforward and feedback information between a Dynamic Range Compressor 13 (FIG. 6) and Video Encoder 14 is achieved in several embodiments. In one embodiment, the Dynamic Range Compressor 13 delivers the Adjusted Digital Image(s) 17 with Feedforward 16 information to the Video Encoder 14 without using and Feedback 15 information from the Video Encoder 14. In this simple approach, the Dynamic Range Compressor 13 pipelines the image and associated

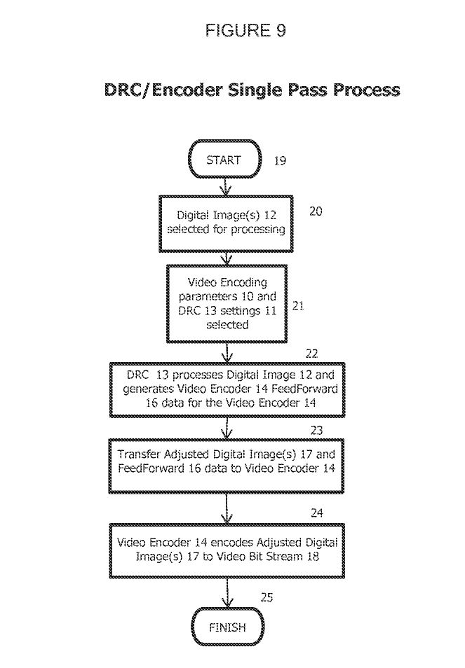

Feedforward 15 information to the Video Encoder 14 for which it makes its best attempt at optimizing the encoding process. Feedback 15 may be available to the Dynamic Range Compressor 13 but is not used. FIG. 9 illustrates a flow diagram for a single pass process wherein Feedforward 15 information is not used by the Dynamic Range Compressor 13. In another embodiment, the Video Encoder 14 provides to the Dynamic Range Compressor 13 Feedback 15 information after analyzing the Adjusted Digital (Image(s) 17 (FIG. 8).

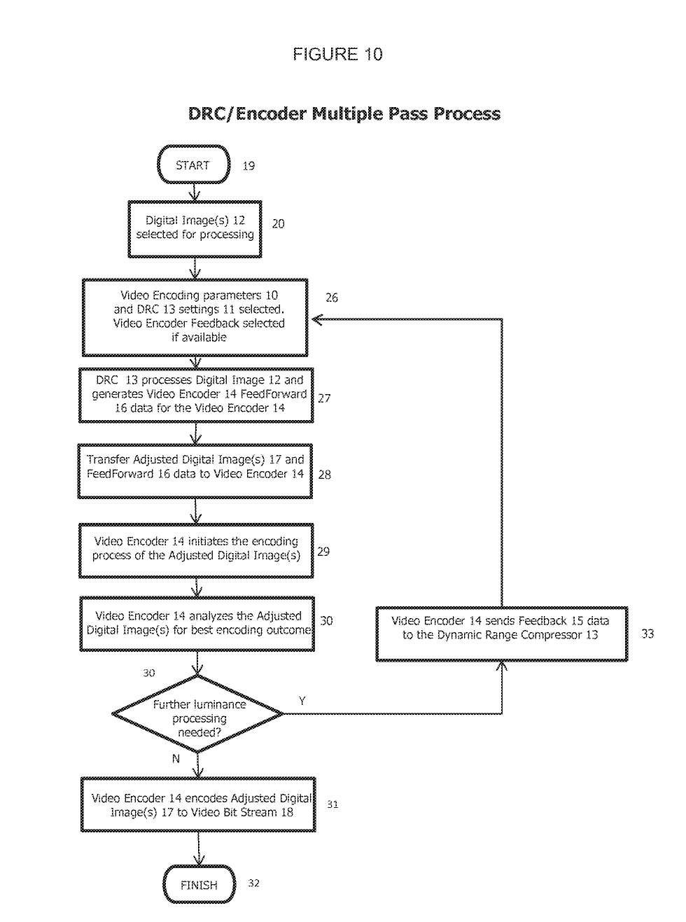

FIG. 10 illustrates a flow diagram for a multiple pass process wherein Feedforward 15 information is used by the Dynamic Range Compressor 13 as part of an iterative process for optimizing the encoded output stream of the Video Encoder 14. The sequence shown in FIG. 10 is similar to that in FIG. 9 except that there are provisions for the Video Encoder 14 and Dynamic Range Compressor 13 (FIG. 6) to iteratively optimize the processing of the image for best results. Sequence step 26 (FIG. 9) allows for any information from the Video Encoder 14 from the Video Encoder 14 Feedback 15 (FIG. 7) information to participate in the DRC process. In addition, sequence step 30, a decision branch, provides a method for iterating the adjustment of DRC 13 settings 11 before a final encoding (sequence step 31) takes place on the Adjusted Digital Image(s) 17. The decision branch, sequence step 30, in one embodiment is dependent upon internal Video Encoder 14 quantizer levels and in another embodiment is dependent upon target Video Encoder 14 target bit rate for the bit stream compressed video 18 (FIG. 7). However, embodiments do not preclude any other metric for deciding the number of iterations between the Video Encoder 14 and Dynamic Range Compressor 13 (FIG. 6).

Intelligent arrangement of image luminance prior to compression provides multiple benefits. These include, but are not limited to, bandwidth savings, enhanced visual fidelity and potential display energy savings on the presentation device. By expanding the intelligence of the luminance arrangement to include participation by the compression block, further increases in benefits are achieved.

Reference in the specification to “one embodiment” or to “an embodiment” means that a particular feature, structure, or characteristic described in connection with the embodiments is included in at least one embodiment. The appearances of the phrase “in one embodiment” or “an embodiment” in various places in the specification are not necessarily all referring to the same embodiment.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations or transformation of physical quantities or representations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device (such as a specific computing machine), that manipulates and transforms data represented as physical (electronic) quantities within the computer system memories or registers or other such information storage, transmission or display devices.

Certain aspects of the embodiments include process steps and instructions described herein in the form of an algorithm. It should be noted that the process steps and instructions of the embodiments can be embodied in software, firmware or hardware, and when embodied in software, could be downloaded to reside on and be operated from different platforms used by a variety of operating systems. The embodiments can also be in a computer program product which can be executed on a computing system.

The embodiments also relate to an apparatus for performing the operations herein. This apparatus may be specially constructed for the purposes, e.g., a specific computer, or it may comprise a computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Memory can include any of the above and/or other devices that can store information/data/programs and can be transient or non-transient medium, where a non-transient or non-transitory medium can include memory/storage that stores information for more than a minimal duration. Furthermore, the computers referred to in the specification may include a single processor or may be architectures employing multiple processor designs for increased computing capability.

The algorithms and displays presented herein are not inherently related to any particular computer or other apparatus. Various systems may also be used with programs in accordance with the teachings herein, or it may prove convenient to construct more specialized apparatus to perform the method steps. The structure for a variety of these systems will appear from the description herein. In addition, the embodiments are not described with reference to any particular programming language. It will be appreciated that a variety of programming languages may be used to implement the teachings of the embodiments as described herein, and any references herein to specific languages are provided for disclosure of enablement and best mode.

In addition, the language used in the specification has been principally selected for readability and instructional purposes, and may not have been selected to delineate or circumscribe the inventive subject matter. Accordingly, the disclosure of the embodiments is intended to be illustrative, but not limiting, of the scope of the embodiments, which is set forth in the claims.

While particular embodiments and applications have been illustrated and described herein, it is to be understood that the embodiments are not limited to the precise construction and components disclosed herein and that various modifications, changes, and variations may be made in the arrangement, operation, and details of the methods and apparatuses of the embodiments without departing from the spirit and scope of the embodiments as defined in the appended claims.

What is claimed is:

1. A system for adjusting the compression of one or more digital images comprising:
an image luminance compressor with video encoder control outputs; and
a video encoder with control inputs coupled to the image luminance compressor control outputs.

2. The system of claim 1, wherein an output of a video encoder controller is coupled to an input of the image luminance compressor.
